(19) United States
(12) Patent Application Publication
(10) Pub. No.: US 2011/0132972 A1
(43) Pub. Date: Jun. 9, 2011

(54) MANUAL METHOD FOR REBALLING USING A SOLDER PREFORM

(75) Inventors: Robert P. Wettermann, Inverness, IL (US); Hung Hoang, Romeoville, IL (US)

(73) Assignee: BEST, INC., Rolling Meadows, IL (US)

(21) Appl. No.: 13/022,226

(22) Filed: Feb. 7, 2011

Related U.S. Application Data
(62) Division of application No. 12/138,901, filed on Jun. 13, 2008.
(60) Provisional application No. 60/934,862, filed on Jun. 15, 2007.

(51) Int. Cl. B23K 31/02

(52) U.S. Cl. 228/119

(57) ABSTRACT

A method for manually reattaching solder balls onto a plurality of contact areas arranged in a pattern on a device to be reballed is provided. First, a single use preform with a plurality of solder balls arranged in a pattern corresponding to the pattern of contact areas on the device is provided. The solder balls are held in respective apertures in the preform by an adhesive layer on the preform that defines a closed end of the apertures and are partially exposed on one side of the preform. A solder paste or paste flux is applied to, at least, the contact areas of the device. The device is manually aligned with the exposed solder balls of the preform and the device and the exposed balls of the preform are manually brought into contact. The aligned device and preform are heated to reflow the solder balls onto the land areas of the device. The preform including the adhesive layer is then removed from the device with the solder balls being retained on the device.

### FIELD OF THE INVENTION

The present invention relates to a method for the manual reattachment of solder balls to area array devices using a solder preform, and more particularly to a rework process for reattaching solder balls onto area array devices which have been removed from a circuit board or require reattachment of different metal alloy solder balls.

### BACKGROUND OF THE INVENTION

In the rework of printed circuit boards, area array devices must from time to time be removed and replaced. In doing so, the removed devices may need to be refurbished and have new balls attached. There are also times when, due to the density of the interconnections, the complexity and high cost of the removed area array device, re-use of the device becomes an important cost consideration. In other cases due to customer requirements, area array devices may require solder balls made of a different alloy. As with a reworked component, in such a case, the alternate alloy solder balls have to be attached to the land areas of the area array device. In each of these cases, the process by which the solder balls are reattached to the device is an important consideration.

In a typical manual solder reballing process, the solder balls are attached on the component pads by screening flux paste or gel on the underside of the component. Preformed solder balls are then forced or shaken into multiple stencil apertures which are aligned with the component pads. The stencil allows the balls to drop into the paste or gel only where pads exist. When the stencil is removed, the balls are held in place by the paste or gel. The assembly is then sent through a reflow source such as an oven to allow the balls to reflow and form an intermettalic layer with the device pads. Upon completion of the heating, the balls are attached metallurgically to the copper pads on the substrate, completing the connection of the integrated circuit package to the printed circuit board. Alternatively, balls having a higher melt temperature solder may be bonded to the pads with the addition of a higher reflow temperature solder paste. These techniques require highly experienced technicians with great dexterity to obtain a reasonable yield in a reasonable period of time.

In other manual methods such as described by Swamyet et al (U.S. Pat. No. 5,392,980), a combination of mechanical fixtures are used to remove components. In the Swamyet method, the device to be reworked is held in an inverted position in the fixture with a stencil overlaid on the device. Solder paste is then pressed through the stencil apertures and the device is reflowed. The properties of the eutectic solder minimize its surface area causing round solder “bumps” to form and balls to remain on the bottom of the device. In the Alghouli method (U.S. Pat. No. 6,769,596), mechanical fixtures are used to hold the solder balls, align the stencil over the device and hold the device into the fixture. In both approaches, extensive tooling and/or fixtures are required in order to reattach the balls onto the device. Thus, these approaches are uneconomical for low quantity area array device rework or where a quick turnaround time is important.

Alternately, a water-soluble paper preform, the manufacturing method for making which is described in Cairncross et al (U.S. Pat. No. 5,356,751), can be used for manual reballing. The paper preform is punched with hole patterns and balls are imbedded such that they are aligned with the pad patterns of the device to be reballed. This type of preform has sped up and simplified the reballing process. However, this technique is plagued by issues associated with the transport and handling of the preforms during which the balls become loose. Moreover, the non-planar nature of the paper preform at times does not allow all balls to adhere to the device pads. There is also limited availability of such preforms for fine-pitched, small ball diameter devices. Lastly, users are inconvenienced by the cleaning of the paper remnants from the preform after reflow and removal.

Accordingly, there continues to be a need for a faster, more reliable method for manually replacing solder balls. The known processes, particularly as the size of the solder balls continues to shrink and the number of I/O on a package grows, require a person of very high skill level. A process by which less skilled rework technicians could rework the devices would be advantageous.

### BRIEF SUMMARY OF THE INVENTION

The present invention comprises a manual rework process for area array packages which either have been previously removed from a printed circuit board assembly or require the reattachment of a solder ball made of a different alloy. The method uses a single-use solder preform comprising a polyimide fixture with an integral adhesive backing which holds the replacement solder balls in place at the correct position. After the balls have been reflowed and mechanically attached to the device being reballed, the entire preform is “peeled” away.

The solder preform generally includes three elements. The first element is a relatively thick fixture having apertures corresponding to the area array pattern of the device being reworked. The fixture can be made of a polyimide material. The second element of the preform is a high temperature tape, which can also be polyimide-based. The tape is attached to the bottom surface such that the adhesive of the tape faces into and forms the bottom of the apertures of the fixture. The last element of the preform is the solder balls that fit into the apertures of the fixture.

A further aspect of the present invention comprises a method by which the above-described preform can be used for reworking an eutectic area array package. This method includes removing the solder balls from the existing device followed by site preparation. Paste flux, designed to withstand the rework process times of area array devices, is then applied to the bottom of the devices. Next, the device is aligned and set on top of the single use preform. The device is then reflowed using a time-temperature profile consistent with the alloy of the solder balls. After reflow, the preform is peeled off leaving the solder balls attached to the pads of the device. Finally, the device is cleaned and inspected.

According to another aspect of the invention, a method for the manual reworking of high temperature alloy solder balled devices is provided. This method also comprises removing the existing solder balls from the device followed by site preparation and cleaning. The solder preform is loaded with the high temperature alloy solder balls and then affixed on a heat-resistant planar plate. Next, solder paste is printed on the pads of the device to be reworked. The preform is then mechanically matched to and aligned with the preprinted pads of the device and placed onto the device. The device is then reflowed using a time-temperature profile consistent with the solder balls being used. After reflow, the solder preform is “peeled off” leaving the solder balls attached to the pads of the device. Lastly, the device is cleaned and inspected.

Another aspect of the invention comprises a method for fabricating the solder preform. The method includes the step of laser ablating apertures into a polyimide sheet in order to create the correct aperture pattern. After the fixture is fabricated, an engineered polyimide tape having a release liner and liquid absorption properties is affixed with the adhesive side facing into the apertures. The solder balls are then loaded onto the apertures. The solder balls are pressed into place via a planar plate which extends generally parallel to the surface supporting the underlying fixture. The balls are then inspected to ensure that their uppermost points all fall within a single, common plane.

### BRIEF DESCRIPTION OF THE SEVERAL VIEWS OF THE DRAWINGS

FIG. 1 is a schematic perspective view of an exemplary polyimide fixture used in the solder reballing preform of the present invention.

FIG. 2 is a schematic side view of an illustrative solder reballing preform without the loaded solder balls.

FIG. 3 is a schematic side view of the solder reballing preform of FIG. 2 with the solder balls loaded into the preform.

FIGS. 4-7 are schematic side views showing exemplary steps of the method according to the present invention in which the solder reballing preform of FIG. 2 is used to reattach eutectic alloy solder balls to an area array device.

FIGS. 8-11 are schematic side view showing exemplary steps of the method according to the present invention in which the solder reballing preform of FIG. 2 is used to reattach high temperature alloy solder balls to an area array.

FIG. 12 is a flow diagram of illustrative steps used in assembling the reballing solder preform of the invention.

FIG. 13 is a flow diagram of illustrative steps used in the process for reballing eutectic alloy solder balls according to the invention.

FIG. 14 is a flow diagram of illustrative steps used in the process for reballing high temperature alloy solder balls according to the invention.

### DETAILED DESCRIPTION OF THE INVENTION

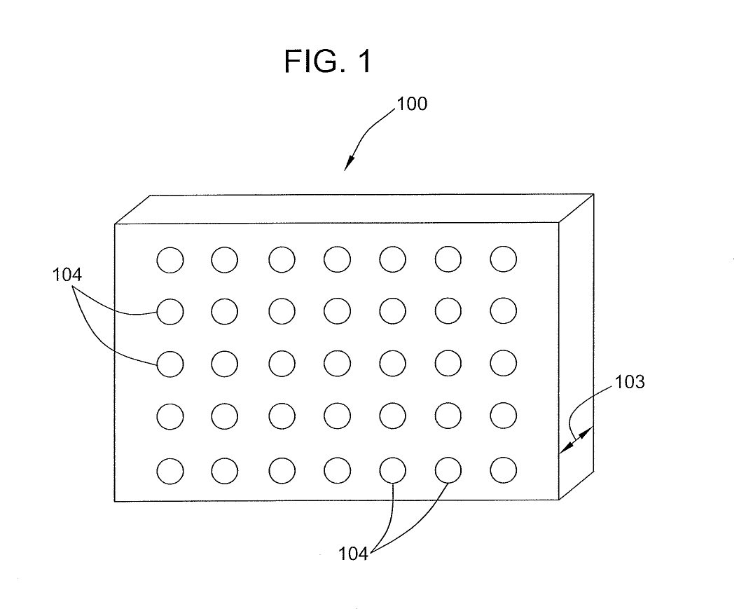

Referring now more particularly to the drawings, an exemplary fixture 100 used in the preform of the present invention to locate and hold a plurality of solder balls in place is shown in FIG. 1. Specifically, a plurality of apertures 104 are foamed in the fixture 100 and provide the means for aligning the solder balls to the pads as well as for holding the solder balls in place. Preferably, the apertures 104 are formed by laser machining. The material properties of the fixture 100 are such that it is suitable for use in an electronics rework and manufacturing area, i.e. the fixture is capable of withstanding the solder reflow temperatures typical of high temperature, tin-lead and so-called lead free (typically a tin-silver-copper alloy) solder alloys and is a non-wettable surface. Because it has a non-wettable surface, good thermal stability properties and is laser machinable, a polyimide or other similar polymer material is preferably used as the fixture 100.

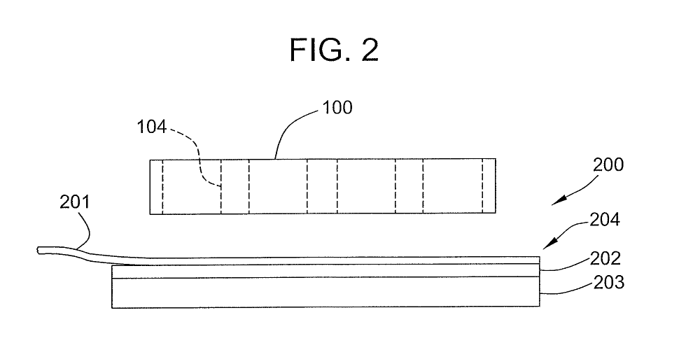

As shown in FIG. 2, a pressure sensitive tape 204 is attached on the underside of the fixture 100 to hold the solder balls in place. This assembly, which is referenced as 200 in the figure, represents an illustrative embodiment of the reballing solder preform of the invention prior to installation of the solder balls. The properties of the tape 204 should include the ability to withstand the reflow temperature range. In this case, the pressure sensitive tape 204 has a high temperature rating and includes a release liner 201 that is peeled off of a carrier 203 to expose an adhesive layer 202. The adhesive layer 202 is then attached to the underside of the stencil 100. The excess area of the tape 204 that is not directly underneath the fixture 100 can be cut away as desired.

The adhesive layer 202 should be formulated to enable the tape 204 to adhere to the bottom side of the fixture 100 and to retain the solder balls in their respective apertures 104 even when the preform is inverted. Additionally, the adhesive layer 202 should be able to maintain its adhesion properties even at the elevated temperatures of the reflow process. Likewise, the carrier 203 also should be thermally stable to at least 275° C. for 90 seconds in order to be able to withstand the reflow cycles. The tape 204 also should be capable of absorbing liquids such as paste fluxes.

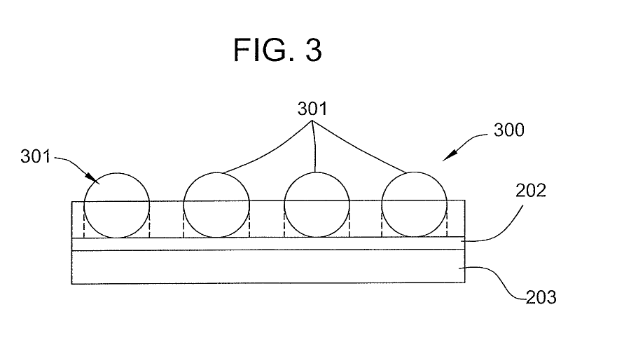

The final preform assembly 300 with the plurality of solder balls 301 inserted is shown in FIG. 3. The bottom surface of the each of the wells defined by the apertures 104 in the fixture 100 and the tape 204 comprises the exposed adhesive layer of the tape. The solder balls 301 are placed into each one of the apertures 104 and into contact with the adhesive layer 202 using a flat planar surface. Once inserted into their respective apertures, the uppermost point of each of the solder balls 301 relative to the surface of the fixture 100 generally should lie in a single common plane that extends parallel to the surface of the fixture 100.

The fixture 100 preferably has a thickness 103 such that at least 60% of the diameter of the solder balls 301 is covered when the balls are in the apertures 104. The apertures 104 of the fixture 100 should be configured such that the solder balls 301 can be freely placed into the apertures 104. However, the fit between the solder balls 301 and the apertures 104 should not be so loose that the balls are off-center relative to the pads on the device being reballed when the preform is used. According to one embodiment, the apertures 104 can have a generally trapezoidal shaped profile that helps ensure that the solder balls 301 are readily held in place in the fixture 100. With apertures 104 having such a configuration, the solder balls 301 are loaded into the fixture 100 from the larger side of a trapezoid. The apertures 104 can be shaped in this fashion due to the nature of the laser ablating process.

The solder balls 301 can be manufactured to industry standard sizes and tolerances and are available in a variety of different alloy types. As noted, during the loading of solder balls 301 into the preform it is important that the uppermost points of the solder balls 301 relative to the surface of the fixture 100 be generally arranged in a single plane and remain so even after shipping to the end user. This helps ensure that upon their attachment to the pads of the device being reballed, each of the solder balls 301 is equidistant from the bottom of the respective ball to the bottom of the device.

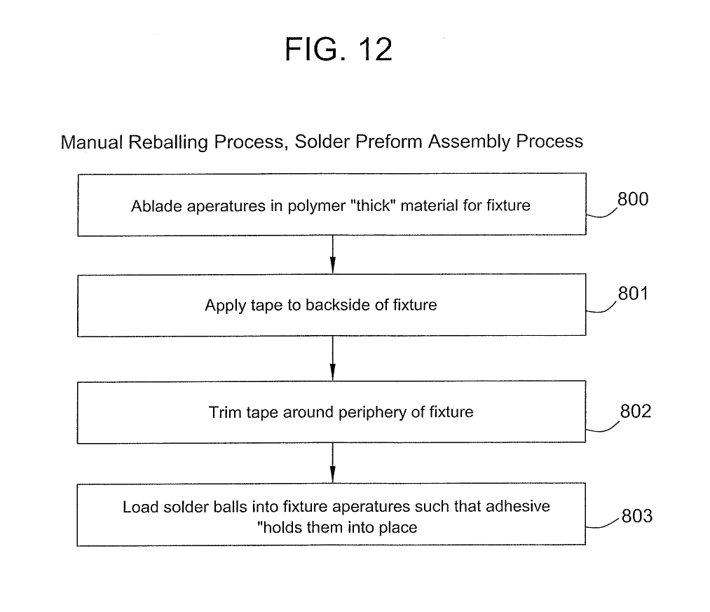

An exemplary method for fabricating the solder preform 300 is shown in the flowchart of FIG. 12. The method includes the step of laser ablating the apertures 104 into a polymer sheet in order to create the fixture 100 with the correct aperture pattern (step 800). After the fixture 100 is fabricated, the tape 204 is affixed to the backside or underside of the fixture 101 with the adhesive layer side facing into the apertures 104 (step 801). Any excess tape 204 around the periphery of the fixture 101 can then be trimmed off as desired (step 802). The tape 204 can also be trimmed into a shape corresponding to the shape of the fixture 100 before the tape is applied to the fixture. The solder balls 301 are then loaded onto the apertures 104 (step 803). The solder balls 301 can be pressed into place via a planar plate which extends generally parallel to the surface supporting the underlying fixture. The balls 301 are then inspected to ensure that their uppermost points all fall within a single, common plane.

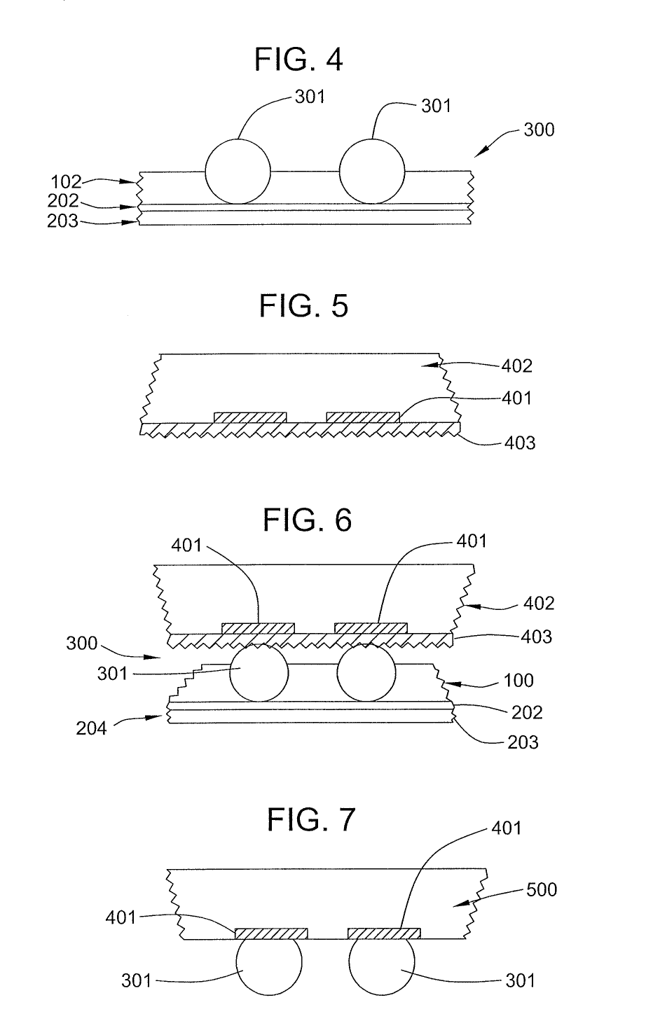

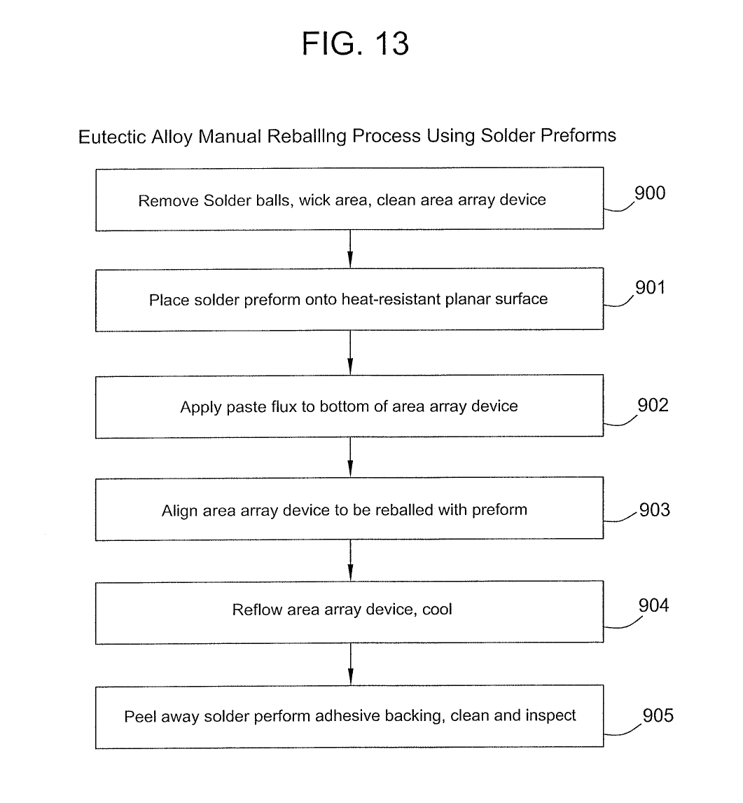

FIGS. 4 through 7 depict an illustrative manual solder ball reballing process using the preform 300 for the reattachment of eutectic alloy solder balls to a device 402, such as an area array device, according to the invention. The steps of this process are also shown in the flow chart of FIG. 13. Preparation of the device 402 to be manually reballed is shown in FIG. 5. The device 402 is prepped by removing the old solder balls and cleaning the pads 401 located on the bottom of the device (step 900 in FIG. 13). After being prepped and cleaned the bottom of the device 402 is coated with paste flux 403 (step 902).

Next, the device 402 and the solder preform 300 can be aligned as shown in FIG. 6. The preform 300 is aligned with the pads 401 of device 402 (step 903) by squaring up the edges of the package of the device 402 to the preform 300. The preform 300 can be placed on a heat resistant planar surface (step 901) either before the alignment step or the preform 300 can be placed on the planar surface after the device 402 is aligned with the preform. The preform 300 and device 402 to be reballed are then sent through a reflow process (step 904). The specifications of the reflow process are determined by the alloy of the solder balls 301. After being cooled the solder preform 300 is pulled off (step 905). The preform 300 is intended for only a single use and can be discarded. The adhesive layer should be formulated such that the solder balls 301 are not pulled off the device 402 when the adhesive is pulled away. The reballed device can then be inspected and cleaned. In this regard, any adhesive residues left on the solder balls after the device has been reballed should be removable with isopropyl alcohol (IPA) or the like so as not to be a source of any ionic contamination (Na, Cl, Br, etc.) that may impact the reliability of the electronic assembly. A completely reballed device, referenced as 500, after reflow, cleaning and inspection is shown in FIG. 7.

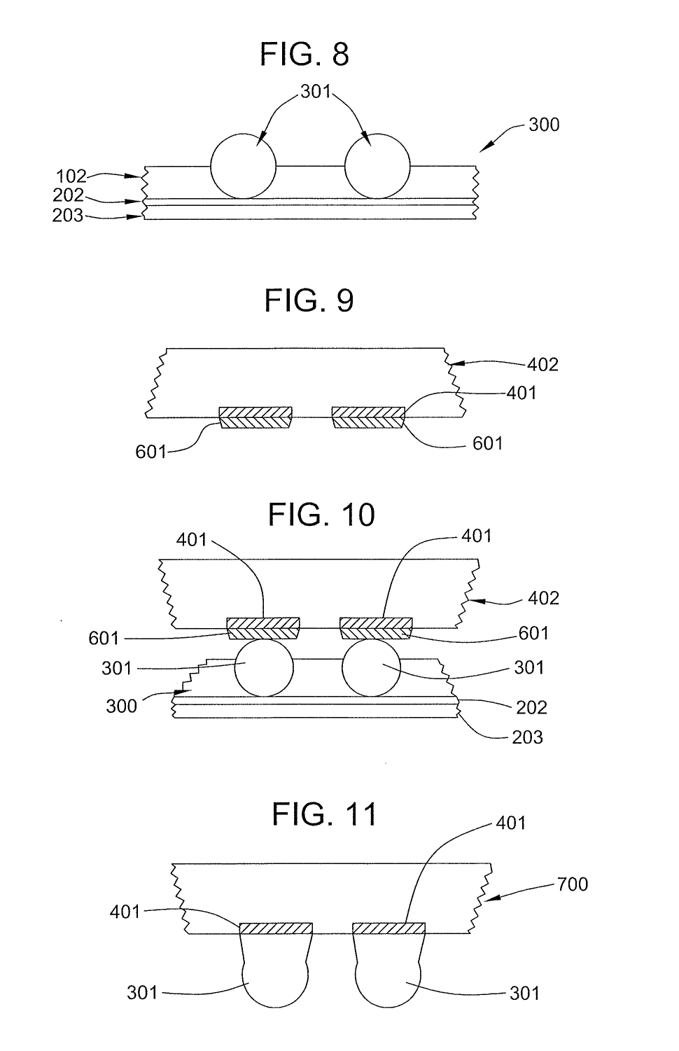

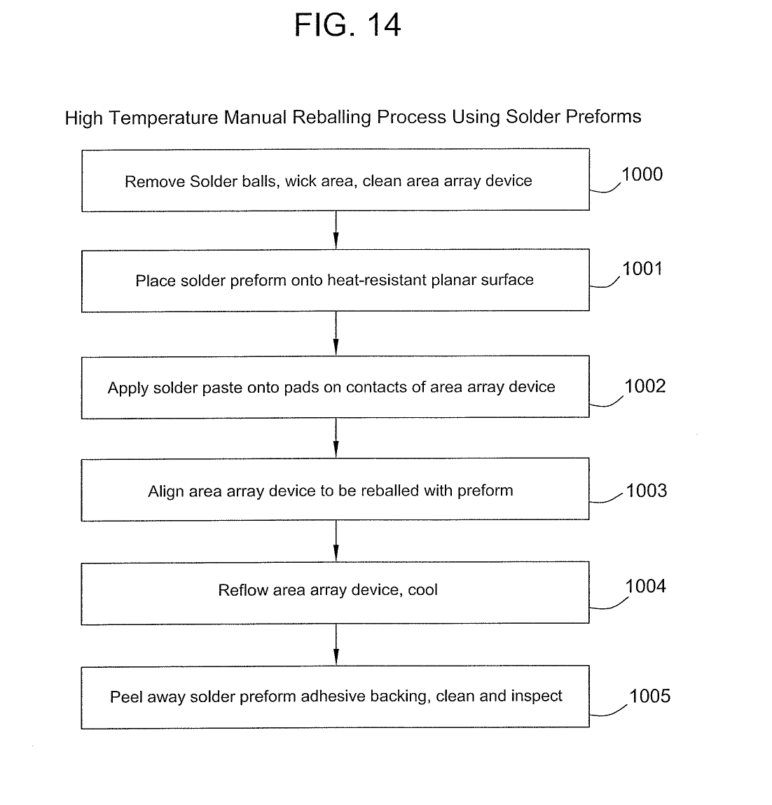

FIGS. 8 through 11 depict another exemplary manual solder ball reballing process using the preform 300 for the reattachment of high temperature alloy solder balls 301 to a device 402 according to the invention. The steps of this process are also shown in the flowchart of FIG. 14. This process is largely the same as that shown in FIGS. 4-7 and 13 except that a solder paste 601 is selectively applied to the device 402 being reballed as opposed to the application of a flux to the entire bottom surface of the device.

Preparation of the device to be manually reballed is shown in FIG. 9. The area array device 402 is prepped by removing the solder balls and cleaning the pads 401 on the bottom of the device 402 (step 1000 in FIG. 14). After being prepped and cleaned, the bottom of the device 402 is stencil printed whereby solder paste 601 is selectively applied to the bottom of the pads 401 (step 1002).

Next, the solder preform 300 is aligned to the device is shown in FIG. 10 (step 1003). The preform 300 is aligned with the pads 401 of the device 402 by squaring up the edges of the package to the solder preform 300. After the preform is aligned to the device, the device 402 and preform 300 are placed on a heat resistant planar surface (step 1001) and sent through a reflow process (step 1004). Again as noted above, if desired, the preform can be placed on the planar surface before the device 402 is aligned with the preform 300. The reflow process specifications are determined by the alloy of the solder balls. After being cooled the solder preform 300 is pulled off (step 1005). The reballed device, referenced as 700, can then be inspected and cleaned as shown in FIG. 11.

From the foregoing, a manual method for reattachment of solder balls for area array devices is disclosed. This process allows for devices to be reused after they have been removed from the PCB or for the replacement of the solder alloy. An advantage of the present invention is that the amount of dexterity required for the manual reballing process is less than other known techniques. This is particularly true when compared to a manual stencil process using an overlay stencil. Such a process can be very tedious given that the solder balls can have diameters of 0.38 mm (15 mils) or less. Such small solder balls are difficult to handle and up to several thousand solder balls need to be loaded into the stencil.

A further advantage of the invention is that the time required for the manual reballing of the device is greatly reduced as compared to the manual stenciling method. The time necessary for the user to load the solder balls into the stencil is eliminated as the solder balls are preloaded into the solder preform. Another advantage of the invention is that all the design and fabrication of the fixtures and stencils is borne by the manufacturer of the preform, instead of being done by the end user. The manufacturer of the solder preforms ensures that the correct stencil geometries and thicknesses are engineered, not the end user. This saves the end user the engineering time required for developing the fixtures and stencils.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A method for manually reattaching solder balls onto a plurality of contact areas arranged in a pattern on a device to be reballed comprising the steps of:
providing a single use preform with a plurality of solder balls arranged in a pattern corresponding to the pattern of contact areas on the device, the solder balls being held in respective apertures in the preform by an adhesive layer on the preform that defines a closed end of the apertures and being partially exposed on one side of the preform;
applying solder paste or paste flux to, at least, the contact areas of the device;
manually aligning the device with the exposed solder balls of the preform and manually bringing the device and the exposed balls of the preform into contact;
heating the aligned device and preform to reflow the solder balls onto the land areas of the device; and
removing the preform including the adhesive layer from the device with the solder balls being retained on the device.

2. The method of claim 1 further including the step of cleaning any remaining adhesive off the device after the preform with the adhesive layer is removed.

3. The method of claim 1 wherein the preform comprises a fixture made of a polyimide material and a tape which includes the adhesive layer.

4. The method of claim 1 wherein the solder paste or flux paste is applied across a surface of the device that includes the contact areas.

5. The method of claim 1 wherein the solder paste or flux paste is applied only to the contact areas.
